(19) United States
(12) Patent Application Publication
(10) Pub. No.: US 2017/0092202 A1
(43) Pub. Date: Mar. 30, 2017

(54) DATA DRIVING INTEGRATED CIRCUIT AND A DISPLAY DEVICE COMPRISING THE SAME

(71) Applicant: SAMSUNG DISPLAY CO., LTD., YONGIN-SI (KR)

(72) Inventors: JIN HO JEONG, SEOUL (KR); WOO IL PARK, YONGIN-SI (KR); DONG WOOK LEE, CHEONAN-SI (KR)

(21) Appl. No.: 15/175,613

(22) Filed: Jun. 7, 2016

(30) Foreign Application Priority Data
Sep. 25, 2015 (KR) 10-2015-0136705

(51) Int. Cl. G09G 3/3291; G09G 3/20

(52) U.S. Cl. CPC G09G 3/3291; G09G 3/2003; G09G 2300/0828; G09G 2310/08

(57) ABSTRACT

A display device includes a timing controller, a data driving IC, and a display unit. The timing controller generates a data control signal and a data image signal based on an external input signal. The data driving IC generates an output image signal based on the data control signal and the data image signal, and applies a data voltage corresponding to the output image signal to n data lines. The display unit connects to the n data lines, and displays an image corresponding to the data voltage. The data driving IC includes a path selector including m path selecting input lines and n path selecting output lines. The data driving IC transmits the output image signal to the path selector through n path selecting input lines selected from among the m path selecting input lines. N is a positive number, and m is an integer greater than n.

### CROSS-REFERENCE TO RELATED APPLICATION

This application claims priority to and the benefit of Korean Patent Application No. 10-2015-0136705 filed in the Korean Intellectual Property Office on Sep. 25, 2015, the disclosure of which is incorporated by reference herein in its entirety.

### TECHNICAL FIELD

The present disclosure relates to a data driving integrated circuit and a display device including the same.

### DISCUSSION OF RELATED ART

A display device may include a liquid crystal display or an organic light emitting display. The display device includes a plurality of pixels and displays an image when a data voltage is applied to the pixels and the pixels emit light according to a plurality of data voltages.

A device for generating a plurality of data voltages and applying the data voltages to the pixels is referred to as a data driving integrated circuit (IC).

The data driving IC may simultaneously apply a plurality of data voltages for each pixel row to a plurality of data lines. Therefore, the data driving IC generally has a plurality of internal wires corresponding to a number of a plurality of pixels included in one pixel row.

When at least one of a plurality of internal wires is unavailable, the data voltage might not be applied to the data line corresponding to the unavailable internal wire. A pixel column corresponding to the data line might not properly emit light and the display device may have a display defect.

### SUMMARY

According to an exemplary embodiment of the present disclosure, a display device includes a timing controller, a data driving IC, and a display unit. The timing controller for generating a data control signal and a data image signal based on an external input signal. The data driving IC for generating an output image signal based on the data control signal and the data image signal, and applies a data voltage corresponding to the output image signal to n data lines. The display unit is connected to the n data lines, and displays an image corresponding to the data voltage. The data driving IC includes a path selector including m path selecting input lines and n path selecting output lines. The data driving IC transmits the output image signal to the path selector through n path selecting input lines selected from among the m path selecting input lines. N is a positive integer, and m is an integer greater than n.

In an exemplary embodiment of the present disclosure, the data driving IC may further include a digital-analog converter for converting a digital image signal into an analog image signal, and the output image signal may be the digital image signal.

In an exemplary embodiment of the present disclosure, the data driving IC may further include a digital-analog converter for converting a digital image signal into an analog image signal, and the output image signal may be the analog image signal.

In an exemplary embodiment of the present disclosure, the digital-analog converter may include m digital-analog converting output lines for outputting the analog image signal, and the m digital-analog converting output lines may be electrically connected to the corresponding m path selecting input lines.

In an exemplary embodiment of the present disclosure, the data driving IC may further include an output buffer for generating the data voltage by amplifying the analog image signal. The output buffer may include n output buffer input lines for receiving the analog image signal. The n output buffer input lines may be electrically connected to the n corresponding path selecting output lines. The output buffer outputs the analog image signal to n corresponding data lines.

In an exemplary embodiment of the present disclosure, the path selector is disposed within the output buffer.

According to an exemplary embodiment of the present disclosure, a data driving IC includes a digital signal processor and a path selector. The digital signal processor includes m digital signal output lines, and outputs a digital image signal through n digital signal output lines selected from among the m digital signal output lines. A path selector includes m path selecting input lines and n path selecting output lines, and the m path selecting input lines are electrically connected to the corresponding m digital signal output lines. The path selector electrically connects n path selecting input lines from among the m path selecting input lines to the corresponding n path selecting output lines. N is a positive integer, and m is an integer greater than n.

In an exemplary embodiment of the present disclosure, the data driving IC may further include a digital-analog converter for converting the digital image signal into an analog image signal. The digital-analog converter may include m digital-analog converting output lines for outputting the analog image signal. The m digital-analog converting output lines may be electrically connected to the corresponding m path selecting input lines.

In an exemplary embodiment of the present disclosure, the data driving IC may further include an output buffer for generating the data voltage by amplifying the analog image signal. The output buffer may include n output buffer input lines for receiving the analog image signal. The n output buffer input lines may be electrically connected to the corresponding n path selecting output lines.

In an exemplary embodiment of the present disclosure, the path selector is disposed within the output buffer.

According to an exemplary embodiment of the present disclosure, a data driving IC includes a digital signal processor, a digital-analog converter, and a path selector. The digital signal processor generates a digital image signal based on a data control signal and a data image signal received from a timing controller. The digital signal processor is electrically connected to a digital-analog converter. The digital-analog converter is electrically connected to a path selector. The path selector includes a plurality of path selecting output lines. A connection between the digital signal processor and the digital-analog converter and a connection between the digital-analog converter and the path selector each includes a plurality of lines and a plurality of repair lines. The path selector connects the plurality of lines and the plurality of repair lines to the corresponding path selecting output lines of the plurality of path selecting output lines. The digital signal processor outputs the digital image signal on a repair line in place of an unavailable line.

In an exemplary embodiment of the present disclosure, the digital-analog converter may convert the digital image signal into an analog image signal.

In an exemplary embodiment of the present disclosure, the path selector may include a plurality of switches. The first terminal of each of the plurality of switches may connect to the plurality of lines or the plurality of repair lines, and a second terminal of each of the plurality of switches is connected to the plurality of path selecting output lines.

In an exemplary embodiment of the present disclosure, the data driving IC may further include an output buffer that generates a data voltage by amplifying the analog image signal. The output buffer may include a plurality of output buffer input lines. The plurality of output buffer input lines may be electrically connected to the corresponding path selecting output lines of the plurality of path selecting output lines. The output buffer may output the data voltage to a plurality of data lines.

### BRIEF DESCRIPTION OF THE DRAWINGS

Exemplary embodiments of the inventive concept will be more clearly understood from the following detailed description taken in conjunction with the accompanying drawings.

FIG. 1 shows a display device according to an exemplary embodiment of the present disclosure.

FIG. 2 shows a data driving IC according to an exemplary embodiment of the present disclosure.

FIGS. 3A and 3B show a path selector according to an exemplary embodiment of FIG. 2.

FIG. 4 shows a data driving IC according to an exemplary embodiment of the present disclosure.

FIGS. 5A and 5B show a path selector according to an exemplary embodiment of FIG. 4.

FIG. 6 shows a data driving IC according to an exemplary embodiment of the present disclosure.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure.

Like reference numerals may designate like element throughout the specification.

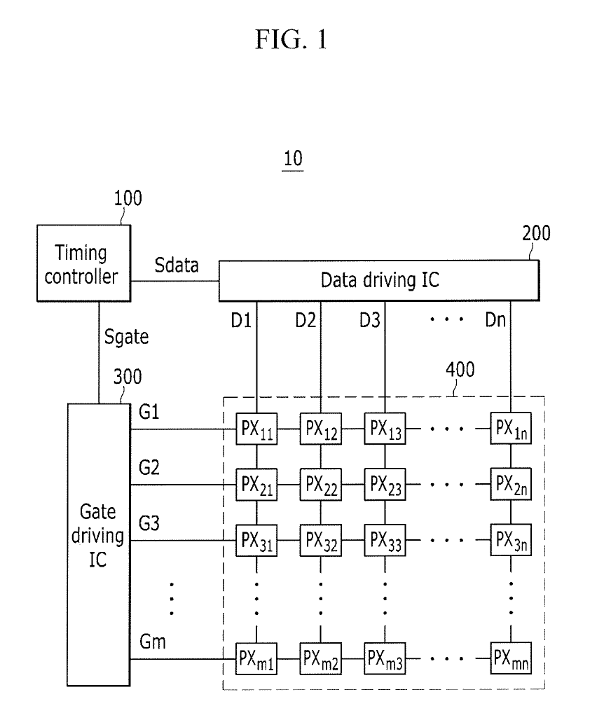

FIG. 1 shows a display device according to an exemplary embodiment of the present disclosure.

Referring to FIG. 1, the display device 10 includes a timing controller 100, a data driving IC 200, a gate driving IC 300, and a display unit 400.

The timing controller 100 generates a data control signal and a data image signal by using an external input signal. The timing controller 100 receives an external input signal from an external graphic controller. The external input signal may include an input image signal and an input control signal.

The input image signal may include luminance information for each pixel, and the luminance may correspond to a predetermined number of grays, for example, 1024, 512, 256, 128, or 64 grays. For example, the input image signal may correspond to red, green, and blue, respectively. The input image signal may be converted into a data image signal appropriate for a specification of the display device 10 in reference to the input control signal. The specification of the display device 10 may include a pixel resolution, a number of data driving ICs, and a number of displayable grays. For example, the display device 10 of FIG. 1 includes a data driving IC 200 and a plurality of m×n pixels (PX11, PX12, PX13, . . . PX1n, PX21, PX22, PX23, . . . PX2n, PX31, PX32, PX33, . . . PX3n, . . . PXm1, PXm2, PXm3, . . . PXmn). In an exemplary embodiment of the present disclosure, the display device may include a plurality of data driving ICs.

The input control signal may include a vertical synchronization signal, horizontal synchronizing signal, main clock signal, data enable signal. The input control signal may be converted into a data control signal and a gate control signal. The gate control signal may include a scanning start signal for instructing a scan start of a gate signal and at least one gate clock signal for controlling an output period of a gate-on voltage. The data control signal may include a horizontal synchronization start signal for notifying a transmission start of an image signal for a pixel row, a data load signal for applying a plurality of data voltages to a plurality of data lines (D1, D2, D3, . . . Dn), and a data clock signal. When the display device 10 is a liquid crystal display, the data control signal may further include an inversion signal for inverting a polarity of a data voltage for a common voltage for each frame, pixel row, or pixel column.

The generated data control signal and the data image signal may be transmitted to the data driving IC 200 through a signal line (Sdata). The generated gate control signal may be transmitted to a gate driving IC 300 through a signal line (Sgate).

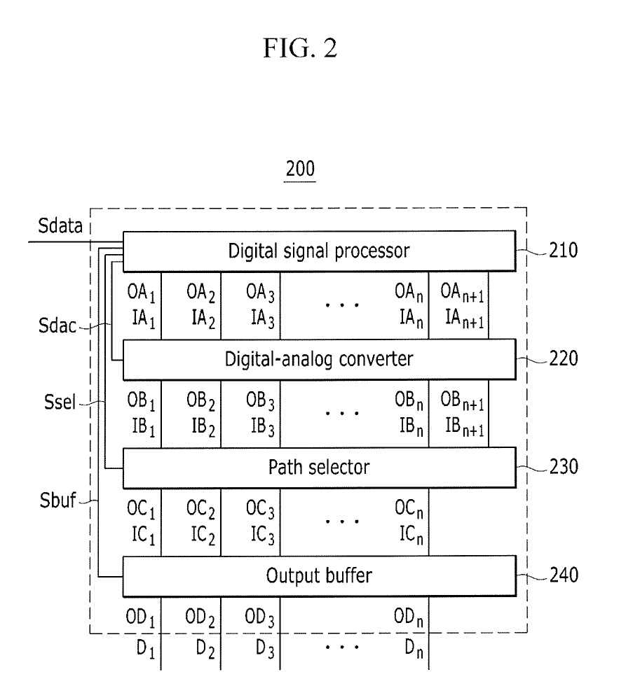

The data driving IC 200 may use the received data control signal and the data image signal to generate an output image signal. The data driving IC 200 converts the output image signal into a corresponding data voltage, and applies the converted data voltage to a plurality of data lines (D1, D2, D3, . . . Dn). The output image signal includes a digital image signal and an analog image signal. The digital image signal and the analog image signal will be described in detail with reference to FIG. 2.

The gate driving IC 300 receives a gate control signal from the timing controller 100 through the signal line (Sgate). The gate driving IC 300 controls the activation of a plurality of pixel rows through a plurality of gate lines (G1, G2, G3, . . . Gm). When the pixel row is on, a plurality of data voltages may be written to the pixel rows provided by the data driving IC 200 to the corresponding pixel row.

The display unit 400 may include a plurality of pixels (PX11, PX12, PX13, . . . PX1n, PX21, PX22, PX23, . . . PX2n, PX31, PX32, PX33, . . . PX3n, . . . PXm1, PXm2, PXm3, . . . PXmn) that are arranged in a matrix form. To realize color expression, each pixel may express one primary color (e.g., spatial division) or may alternately express the primary colors with respect to time (e.g., temporal division) so that a desired color may be recognized by a spatial or temporal sum of the primary colors. The primary colors may be one of three primary colors, such as red, green, and blue, or may be one of yellow, cyan, and magenta. A plurality of pixels displaying different primary colors may form a single set (hereinafter, a dot), and one dot maybe capable of displaying any desired color.

Each pixel may include at least one transistor. The transistor may be connected to at least one data line and at least one gate line. When a gate line is connected to a control electrode of the transistor and the transistor is turned on, the data voltage applied to the data line is applied to the corresponding pixel through the active transistor.

FIG. 2 shows a data driving IC according to an exemplary embodiment of the present disclosure.

Referring to FIG. 2, the data driving IC 200 includes a digital signal processor 210, a digital-analog converter 220, a path selector 230, and an output buffer 240.

The digital signal processor 210 receives a data control signal and a data image signal from the timing controller 100 through the signal line (Sdata). The digital signal processor 210 analyzes the data control signal and the data image signal to generate a digital image signal, and controls the digital-analog converter 220, the path selector 230, and the output buffer 240. The digital signal processor 210 is connected to the digital-analog converter 220 through a signal line (Sdac). The digital signal processor 210 is connected to the path selector 230 through a signal line (Ssel). The digital signal processor 210 is connected to the output buffer 240 through a signal line (Sbuf). Connection states of the constituent elements (210, 220, 230, and 240) included in the data driving IC 200 may be different for each exemplary embodiment. For example, in FIG. 2, the digital signal processor 210 is connected to the constituent elements 220, 230, and 240 through different signal lines, and the constituent elements 210, 220, 230, and 240 may share a bus.

The digital signal processor 210 includes n+1 digital signal output lines (OA1, OA2, OA3, . . . OAn, OAn+1). The plurality of digital signal output lines may include one or more repair lines. A repair line is capable of transmitting a digital image signal in place of an unavailable digital signal output line. The digital signal processor 210 with one repair line is shown in the exemplary embodiment shown in FIG. 2, but the disclosure is not limited thereto. For ease of description, one repair line will be exemplified.

In an exemplary embodiment of the present disclosure, the digital signal processor 210 outputs a digital image signal through n selected digital signal output lines from among n+1 digital signal output lines (OA1, OA2, OA3, . . . OAn, OAn+1). The n selected digital signal output lines represent the rest of the digital signal output lines except one unavailable digital signal output line from among the n+1 digital signal output lines (OA1, OA2, OA3, . . . OAn, OAn+1). The unavailable digital signal output line represents a damaged digital signal output line. Damage in a digital signal output line may occur in at least one of the corresponding digital-analog converting input line, the digital-analog converting output line, the path selecting input line, and another circuit provided among them. Damage in the unavailable digital signal output line results in the data voltage not being properly applied to the corresponding data line.

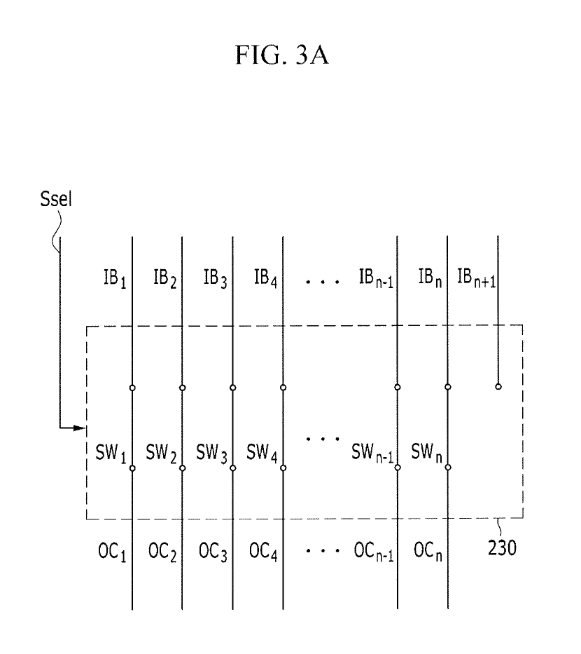

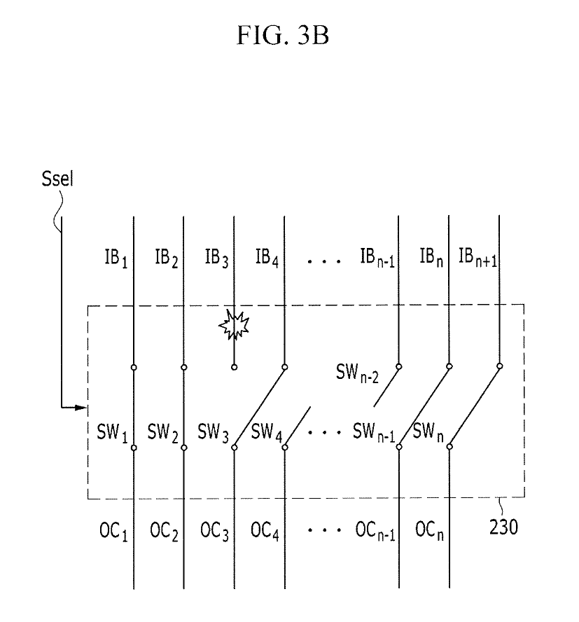

When the data voltage is not properly applied to the corresponding data line, a display defect issue occurs, such as the corresponding pixel column does not emit light. A worker may find the display defect issue during the manufacturing process or a consumer may check the defective display and request its repair. The worker may repair the data driving IC 200 so that the digital image signal may be transmitted to the n digital signal output lines, except for the unavailable digital signal output line. The path selector 230 is controlled by the selected n digital signal output lines, which will be described in detail with reference to FIG. 3A and FIG. 3B.

Further, the unavailable digital signal output line is detected, the digital image signal is transmitted through the normal digital signal output line, and the path selector 230 may be controlled by the selected digital output line. The display device 10 may detect the data line from which the abnormal data voltage is transmitted. The display device may determine that a digital signal output line corresponding to the data line with the abnormal data voltage may be unavailable.

The digital-analog converter (DAC) 220 converts the received digital image signal into an analog image signal. The digital-analog converter 220 includes n+1 digital-analog converting input lines (IA1, IA2, IA3, . . . IAn, IAn+1) and n+1 digital-analog converting output lines (OB1, OB2, OB3, . . . OBn, OBn+1). The n+1 digital-analog converting input lines (IA1, IA2, IA3, . . . IAn, IAn+1) are connected to the n+1 digital signal output lines (OA1, OA2, OA3, . . . OAn, OAn+1). The n+1 digital-analog converting output lines (OB1, OB2, OB3, . . . OBn, OBn+1) are connected to the n+1 path selecting input lines (IB1, IB2, IB3, . . . IBn, IBn+1).

The digital-analog converter 220 receives a digital image signal through the n digital-analog converting input lines (IA1, IA2, IA3, . . . IAn) corresponding to the n selected digital signal output lines (OA1, OA2, OA3, . . . OAn). The digital-analog converter 220 converts the digital image signal into an analog image signal, and outputs an analog image signal through the n corresponding digital-analog converting output lines (OB1, OB2, OB3, . . . OBn).

The display device 10 may further include a gray voltage generator, and the digital-analog converter 220 may use a gray voltage or a gray reference voltage generated by a gray voltage generator to generate an analog image signal.

The path selector 230 includes n+1 path selecting input lines (IB1, IB2, IB3, . . . IBn, IBn+1) and n path selecting output lines (OC1, OC2, OC3, . . . OCn). The path selector 230 electrically connects the n path selecting input lines corresponding to the n digital signal output lines selected according to a control signal by the digital signal processor 210 to the n path selecting output lines. An operation of the path selector 230 will be described in detail with reference to FIG. 3A and FIG. 3B.

The output buffer 240 amplifies an analog image signal to generate a data voltage. The display device 10 may further include a driving voltage generator. The output buffer 240 may use a driving voltage generated by a driving voltage generator to operate a plurality of amplification circuits. The output buffer 240 may use the amplification circuits to amplify the analog image signal into a data voltage. An amplification ratio may be controlled by the digital signal processor 210.

The output buffer 240 may include n output buffer input lines (IC1, IC2, IC3, . . . ICn) and n output buffer output lines (OD1, OD2, OD3, . . . ODn). The n output buffer input lines (IC 1, IC2, IC3, . . . ICn) are electrically connected to the n path selecting output lines (OC1, OC2, OC3, . . . OCn). The n output buffer output lines (OD1, OD2, OD3, . . . ODn) are electrically connected to a plurality of data lines (D1, D2, D3, . . . Dn).

FIG. 3A and FIG. 3B show a path selector according to an exemplary embodiment of FIG. 2. Referring to FIG. 3A and FIG. 3B, the path selector 230 includes n switches (SW1, SW2, SW3, SW4, . . . SWn−1, SWn) for selectively connecting n+1 path selecting input lines (IB1, IB2, IB3, IB4, . . . IBn−1, IBn, IBn+1) and n path selecting output lines (OC1, OC2, OC3, OC4 . . . OCn−1, OCn). The path selector 230 may be a single multiplexer or a combination of a plurality of multiplexers.

The n switches (SW1, SW2, SW3, SW4, . . . SWn−1, SWn) of the path selector 230 are controlled by the digital signal processor 210 through the signal line (Ssel). The digital signal processor 210 controls the n switches (SW1, SW2, SW3, SW4, . . . SWn−1, SWn) with a default control value in a normal driving state in which the digital-analog converting input line, the digital-analog converting output line, the path selecting input line, and the other circuits provided therebetween operate normally. According to the default control value, as shown in FIG. 3A, the switches (SW1, SW2, SW3, SW4, . . . SWn−1, SWn) may be controlled so that the n path selecting input lines (IB1, IB2, IB3, IB4 . . . IBn−1, IBn) may be electrically connected to the n corresponding path selecting output lines (OC1, OC2, OC3, OC4 . . . OCn−1, OCn). In this case, the path selecting input line (IBn+1), the digital-analog converting output line (OBn+1), the digital-analog converting input line (IAn+1), and the digital signal output line (OAn+1) are repair lines and are not used to transmit the image signal.

According to an exemplary embodiment of the present disclosure, when at least one of the path selecting input line IB3, the digital-analog converting output line OB3, the digital-analog converting input line IA3, the digital signal output line OA3, and the other circuits provided therebetween are unavailable, the digital signal processor 210 controls the switches (SW1, SW2, SW3, . . . SWn−1, SWn), as shown in FIG. 3B.

The digital signal processor 210 shifts the digital image signal output to the third digital signal output line OA3, by one line, so that the digital image signal may be output to the fourth digital signal output line OA4. The digital signal processor 210 controls the digital image signal output to the fourth digital signal output line OA4 and shifts the digital image signal to be output to the fifth digital signal output line OA5. The digital signal processor 210 shifts the digital image signal output to the (n−1)th digital signal output line (OAn−1) to be output to the n-th digital signal output line (OAn), and shifts the digital image signal output to the n-th digital signal output line (OAn) to be output to the (n+1)th digital signal output line (OAn+1).

Referring to FIG. 3B, the switches SW1 and SW2 electrically connect the corresponding path selecting input lines IB1 and IB2 to the path selecting output lines OC1 and OC2 in a manner similar to FIG. 3A.

The switches (SW3, . . . SWn−2, SWn−1, SWn) electrically connect the path selecting input lines (IB4 . . . IBn−1, IBn, IBn+1) except the path selecting input line IB3 to the path selecting output lines (OC3, OC4 . . . OCn−1, OCn).

According to the present exemplary embodiment of the present disclosure, the (n+1)th line is provided as a repair line so that when one of the n internal wires of the data driving IC 200 becomes unavailable, the data driving IC 200 or the display device 10 may be easily repaired.

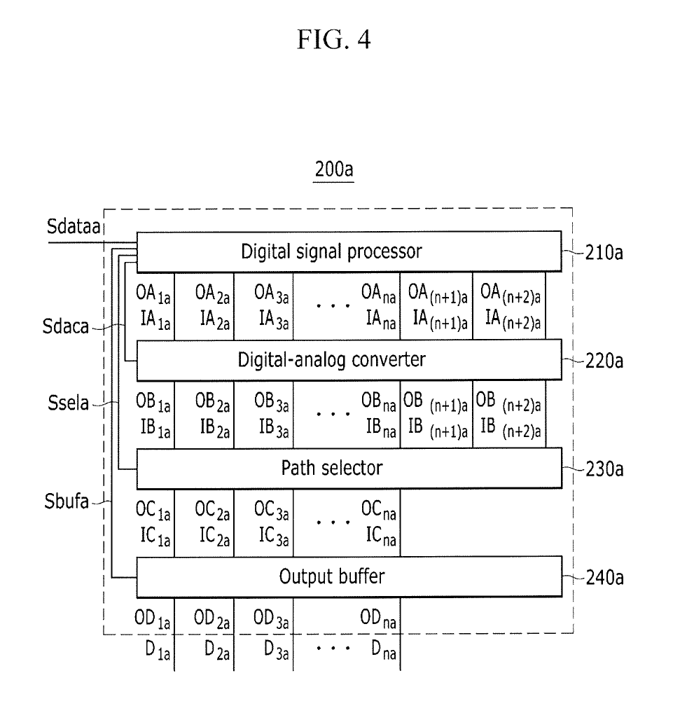

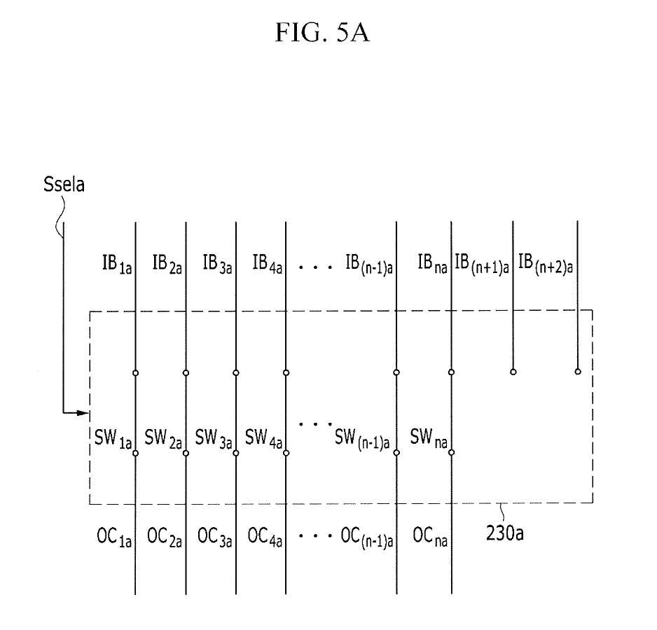

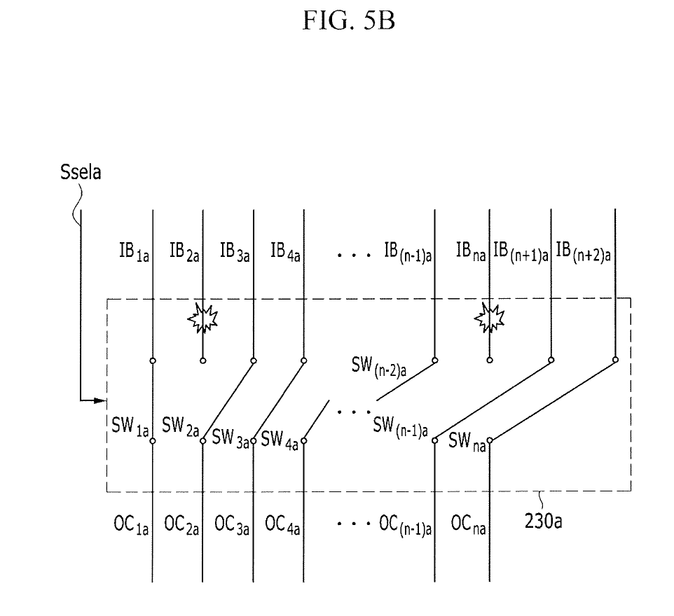

One repair line is provided in the present exemplary embodiment, but a plurality of repair lines may be provided and may be switched with a plurality of unavailable lines. An exemplary embodiment of the present disclosure for providing a plurality of repair lines will now be described with reference to FIG. 4, FIG. 5A, and FIG. 5B.

When FIG. 4, FIG. 5A, and FIG. 5B are described, for convenience of description, duplicate portions will be omitted.

FIG. 4 shows a data driving IC according to an exemplary embodiment of the present disclosure.

Referring to FIG. 4, the data driving IC 200a includes a digital signal processor 210a, a digital-analog converter 220a, a path selector 230a, and an output buffer 240a. The digital signal processor 210a is connected to the digital-analog converter 220a through a signal line (Sdaca). The digital signal processor 210a is connected to the path selector 230a through a signal line (Ssela). The digital signal processor 210a is connected to the output buffer 240a through a signal line (Sbufa).

The digital signal processor 210a receives a data control signal and a data image signal from a timing controller through a signal line (Sdataa). The digital signal processor 210a includes n+2 digital signal output lines (OA1a, OA2a, OA3a, . . . OAna, OA (n+1)a, OA (n+2)a). The digital signal processor 210 outputs a digital image signal through n digital signal output lines OAna selected from among n+2 digital signal output lines (OA1a, OA2a, OA3a, . . . OAna, OA (n+1)a, OA (n+2)a).

The digital-analog converter 220a includes n+2 digital-analog converting input lines (IA1a, IA2a, IA3a, . . . IAna, IA (n+1)a, IA (n+2)a) and n+2 digital-analog converting output lines (OB1a, OB2a, OB3a, . . . OBna, OB (n+1)a, OB (n+2)a). The n+2 digital-analog converting input lines (IA1a, IA2a, IA3a, . . . IAna, IA (n+1)a, IA (n+2)a) are connected to the n+2 digital signal output lines (OA1a, OA2a, OA3a, . . . OAna, OA (n+1)a, OA (n+2)a). The n+2 digital-analog converting output lines (OB1a, OB2a, OB3a, . . . OBna, OB (n+1)a, OB (n+2)a) are connected to the n+2 path selecting input lines (IB1a, IB2a, IB3a, . . . IBna, IB (n+1)a, IB (n+2)a).

The digital-analog converter 220a receives a digital image signal through n digital-analog converting input lines IAna corresponding to the n digital signal output lines. The digital-analog converter 220a converts the digital image signal into an analog image signal. The digital-analog converter 220a outputs the analog image signal through n corresponding digital-analog converting output lines (OB1a, OB2a, OB3a, . . . OBna).

The path selector 230a includes n+2 path selecting input lines (IB1a, IB2a, IB3a, . . . IBna, IB (n+1)a, IB (n+2)a) and n path selecting output lines (OC1a, OC2a, OC3a, . . . OCna). The path selector 230a electrically connects the n path selecting input lines (IB1a, IB2a, IB3a, . . . IBna) corresponding to the n digital signal output lines (OA1a, OA2a, OA3a, . . . OAna) selected according to a control by the digital signal processor 210a to the n path selecting output lines (OC1a, OC2a, OC3a, . . . OCna). An operation of the path selector 230a will be described in detail with reference to FIG. 5A and FIG. 5B.

The output buffer 240a may include n output buffer input lines (IC1a, IC2a, IC3a, . . . ICna) and n output buffer output lines (OD1a, OD2a, OD3a, . . . ODna). The n output buffer input lines (IC1a, IC2a, IC3a, . . . ICna) are electrically connected to the n path selecting output lines (OC1a, OC2a, OC3a, . . . OCna). The n output buffer output lines (OD1, OD2, OD3, . . . ODn) are electrically connected to a plurality of data lines (D1a, D2a, D3a, . . . Dna).

FIG. 5A and FIG. 5B show a path selector according to an exemplary embodiment of FIG. 4. Referring to FIGS. 5A and 5B, the path selector 230a includes n switches (SW1a, SW2a, SW3a, SW4a, . . . SW (n−1)a, SWna) for selectively connecting n+2 path selecting input lines (IB1a, IB2a, IB3a, IB4a, . . . IB (n−1)a, IBna, IB (n+1)a, IB (n+2)a) and n path selecting output lines (OC1a, OC2a, OC3a, OC4a, . . . OC (n−1)a, OCna).

The n switches (SW1a, SW2a, SW3a, SW4a, . . . SW (n−1)a, SWna) of the path selector 230a are controlled by the digital signal processor 210a through the signal line (Ssela). The digital signal processor 210a controls the n switches (SW1a, SW2a, SW3a, SW4a, . . . SW (n−1)a, SWna) with a default control value in the normal driving state in which no defects are detected on the digital-analog converting input line, the digital-analog converting output line, the path selecting input line, and the other circuits provided therebetween. According to the default control value, as shown in FIG. 5A, the switches (SW1a, SW2a, SW3a, SW4a, . . . SW (n−1a), SWna) may be controlled so that the n path selecting input lines (IB1a, IB2a, IB3a, IB4a, . . . IB (n−1)a, IBna) may be electrically connected to the n corresponding path selecting output lines (OC1a, OC2a, OC3a, OC4a, . . . OC (n−1)a, OCna). The path selecting input lines (IB (n+1)a and IB (n+2)a), the digital-analog converting output lines (OB (n+1)a and OB (n+2)a), the digital-analog converting input lines (IA (n+1)a and IA (n+2)a), and the digital signal output lines (OA (n+1)a and OA (n+2)a) that are (n+1)th and (n+2)th lines are repair lines, and are not used.

However, for example, when at least one of the path selecting input lines (IB2a and IBna), the digital-analog converting output lines (OB2a and OBna), the digital-analog converting input lines (IA2a and IAna), the digital signal output lines (OA2a and OAna) that are second and n-th lines, and the other circuits provided therebetween, the digital signal processor 210 controls the switches (SW1a, SW2a, SW3a, SW4a, . . . SW (n−1)a, SWna), as shown in FIG. 5B. The digital signal processor 210 shifts the digital image signal output to the third digital signal output line OA3a, by one line, so that the digital image signal may be output to the fourth digital signal output line OA4a.

The digital signal processor 210a controls the digital image signal output to the second digital signal output line OA2a to be output to the third digital signal output line OA3a. The digital signal processor 210a controls the digital image signal output to the third digital signal output line OA3a to the fourth digital signal output line OA4a. The digital signal processor 210a controls the digital image signal output to the (n−2)th digital signal output line to be output to the (n−1)th digital signal output line. The digital signal processor 210a controls the digital image signal output to the (n−1)th digital signal output line through the (n+1)th digital signal output line OA n+la. The digital signal processor 210a controls the digital image signal output to the n-th digital signal output line OAna through the (n+2)th digital signal output line OA (n+2)a.

Referring to FIG. 5B, the switch SW1a electrically connects the corresponding path selecting input line IB1a and the path selecting output line OC1a in a like manner as FIG. 5A.

However, the switches (SW2a, SW3a, SW4a, . . . SW (n−2)a, SW (n−1)a, SWna) may electrically connect the path selecting input lines (IB1a, IB3a, IB4a, . . . IB (n−1)a, IB (n+1)a, IB (n+2)a), except the path selecting input lines (IB2a and IBna), to the path selecting output lines (OC2a, OC3a, OC4a, . . . OC (n−1)a, OCna).

According to an exemplary embodiment of the present disclosure, the (n+1)th and (n+2)th lines are provided as repair lines so that when one of the n internal wires of the data driving IC 200a becomes unavailable, the data driving IC 200a or the display device may be easily repaired.

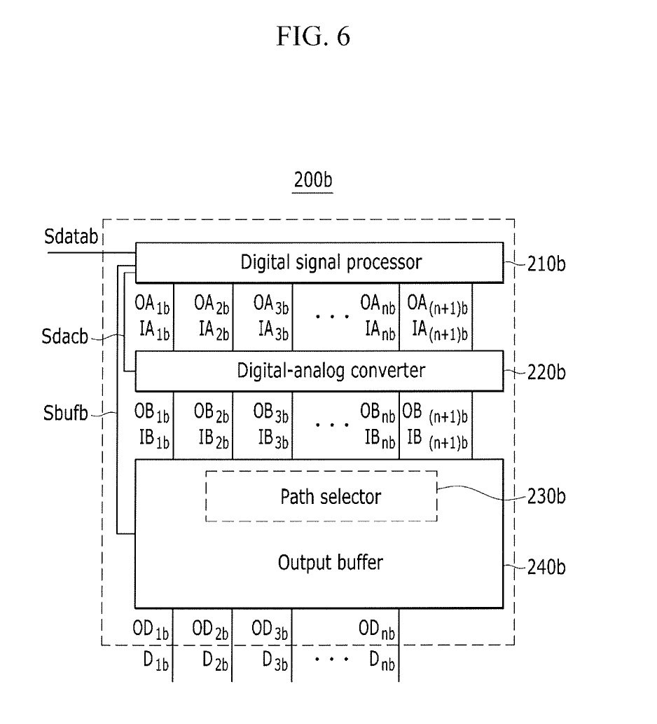

FIG. 6 shows a data driving IC according to an exemplary embodiment of the present disclosure. When FIG. 6 is described, for convenience of description, duplicate portions will be omitted.

Referring to FIG. 6, the data driving IC 200b includes a digital signal processor 210b, a digital-analog converter 220b, and an output buffer 240b. The digital signal processor 210b is connected to the digital-analog converter 220b through a signal line (Sdacb). The digital signal processor 210b is connected to the output buffer 240b through a signal line (Sbufb).

The digital signal processor 210b receives a data control signal and a data image signal from a timing controller through a signal line (Sdatab). The digital signal processor 210b includes n+1 digital signal output lines (OA1b, OA2b, OA3b, . . . OAnb, OA (n+1)b). The digital signal processor 210b outputs a digital image signal through the n selected digital signal output lines from among n+1 digital signal output lines (OA1b, OA2b, OA3b, . . . OAnb, OA (n+1)b).

The digital-analog converter 220b includes n+1 digital-analog converting input lines (IA1b, IA2b, IA3b, . . . IAnb, IA (n+1)b, IA (n+2)b) and n+1 digital-analog converting output lines (OB1b, OB2b, OB3b, . . . OBnb, OB (n+1)b). The n+1 digital-analog converting input lines (IA1b, IA2b, IA3b, . . . IAnb, IA (n+1)b) are connected to the n+1 digital signal output lines (OA1b, OA2b, OA3b, . . . OAnb, OA (n+1)b). The n+1 digital-analog converting output lines (OB1b, OB2b, OB3b, . . . OBnb, OB (n+1)b) are connected to the n+1 output buffer input lines (IB1b, IB2b, IB3b, . . . IBnb, IB (n+1)b).

The digital-analog converter 220b receives a digital image signal through the n digital-analog converting input lines (IA1b, IA2b, IA3b, . . . IAnb) corresponding to the n digital signal output lines (OA1b, OA2b, OA3b, . . . OAnb). The digital-analog converter 220b converts the digital image signal into an analog image signal. The digital-analog converter 220b outputs the analog image signal through the n corresponding digital-analog converting output lines (OB1b, OB2b, OB3b, . . . OBnb).

The output buffer 240b may include n+1 output buffer input lines (IB1b, IB2b, IB3b, . . . IBnb, IB (n+1)b) and n output buffer output lines (OD1b, OD2b, OD3b, . . . ODnb). The n output buffer output lines (OD1b, OD2b, OD3b, . . . ODnb) are electrically connected to a plurality of data lines (D1b, D2b, D3b, . . . Dnb).

In the present exemplary embodiment of the present disclosure, the output buffer 240b is integrally formed with the path selector 230b. For example, the path selector 230b may be disposed within the output buffer 240b. The path selector 230b selectively connects m input lines to n output lines. Here, n is a positive integer, and m is an integer greater than n. In the present exemplary embodiment, m is equal to n+1. Therefore, the n+1 output buffer input lines (IB1b, IB2b, IB3b, . . . IBnb, IB (n+1)b) may be selectively connected to the n output buffer output lines (OD1b, OD2b, OD3b, . . . ODnb) through the path selector 230b.

According to an exemplary embodiment of the present disclosure, a data driving IC includes a digital signal processor, a digital-analog converter, and an output buffer. The digital signal processor is connected to the digital-analog converter through a signal line. The digital-analog converter is connected to the output buffer through a signal line. The output buffer is connected to the path selector through a signal line. The signal line connecting the output buffer to the path selector may include n lines for transmitting data and m repair lines. Here, n is a positive integer, and m is an integer greater than n. In the present exemplary embodiment of the present disclosure, m is equal to n+1.

The accompanying drawings and the exemplary embodiments of the present disclosure are only examples of the present disclosure, and are used to describe the present disclosure but do not limit the scope of the present disclosure. Accordingly, it will be understood by those of skill in the art that various changes in form and details may be made without departing from the spirit and scope of the present disclosure.

What is claimed is:

1. A display device comprising:
a timing controller for generating a data control signal and a data image signal based on an external input signal;
a data driving IC for generating an output image signal based on the data control signal and the data image signal, the data driving IC applying a data voltage corresponding to the output image signal to n data lines; and
a display unit connected to the n data lines, the display unit displaying an image corresponding to the data voltage,
wherein the data driving IC includes a path selector including m path selecting input lines and n path selecting output lines,
wherein the data driving IC transmits the output image signal to the path selector through n path selecting input lines selected from among the m path selecting input lines, and
wherein n is a positive integer, and m is an integer greater than n.

2. The display device of claim 1, wherein
the data driving IC further includes a digital-analog converter for converting a digital image signal into an analog image signal, and
the output image signal is the digital image signal.

3. The display device of claim 1, wherein
the data driving IC further includes a digital-analog converter for converting a digital image signal into an analog image signal, and
the output image signal is the analog image signal.

4. The display device of claim 3, wherein
the digital-analog converter includes m digital-analog converting output lines for outputting the analog image signal, and
the m digital-analog converting output lines are electrically connected to the corresponding m path selecting input lines.

5. The display device of claim 3, wherein
the data driving IC further includes an output buffer for generating the data voltage by amplifying the analog image signal,
the output buffer includes n output buffer input lines for receiving the analog image signal,
the n output buffer input lines are electrically connected to the corresponding n path selecting output lines, and
the output buffer outputs the analog image signal to n corresponding data lines.

6. The display device of claim 5, wherein
the path selector is disposed within the output buffer.

7. A data driving IC comprising:
a digital signal processor including m digital signal output lines, and that outputs a digital image signal through n digital signal output lines selected from among the m digital signal output lines; and
a path selector including m path selecting input lines and n path selecting output lines, and the m path selecting input lines are electrically connected to the corresponding m digital signal output lines,
wherein the path selector electrically connects n path selecting input lines from among the m path selecting input lines to the corresponding n path selecting output lines, and
wherein n is a positive integer, and m is an integer greater than n.

8. The data driving IC of claim 7, further comprising
a digital-analog converter for converting the digital image signal into an analog image signal,
wherein the digital-analog converter includes m digital-analog converting output lines for outputting the analog image signal, and
the m digital-analog converting output lines are electrically connected to the corresponding m path selecting input lines.

9. The data driving IC of claim 8, further comprising
an output buffer for generating the data voltage by amplifying the analog image signal,
wherein the output buffer includes n output buffer input lines for receiving the analog image signal, and
the n output buffer input lines are electrically connected to the corresponding n path selecting output lines, and
the output buffer outputs the analog image signal to n corresponding data lines.

10. The data driving IC of claim 9, wherein
the path selector is disposed within the output buffer.

11. A data driving IC comprising:
a digital signal processor that generates a digital image signal based on a data control signal and a data image signal received from a timing controller, wherein the digital signal processor is electrically connected to a digital-analog converter;
the digital-analog converter electrically connected to a path selector; and
the path selector includes a plurality of path selecting output lines,
wherein a connection between the digital signal processor and the digital-analog converter and a connection between the digital-analog converter and the path selector each include a plurality of lines and a plurality of repair lines,
wherein the path selector connects the plurality of lines and the plurality of repair lines to the corresponding path selecting output lines of the plurality of path selecting output lines, and
wherein the digital signal processor outputs the digital image signal on a repair line in place of an unavailable line.

12. The data driving IC of claim 11, wherein
the digital-analog converter converts the digital image signal into an analog image signal.

13. The data driving IC of claim 11, wherein the path selector includes a plurality of switches,
wherein a first terminal of each of the plurality of switches is connected to the plurality of lines or the plurality of repair lines, and a second terminal of each of the plurality of switches is connected to the plurality of path selecting output lines.

14. The data driving IC of claim 12, further comprising
an output buffer that generates a data voltage by amplifying the analog image signal,
wherein the output buffer is electrically connected to the path selector, and
the output buffer includes a plurality of output buffer input lines, the plurality of output buffer input lines are electrically connected to the corresponding path selecting output lines of the plurality of path selecting output lines, and
the output buffer outputs the data voltage to a plurality of data lines.
